(19) United States
(12) Patent Application Publication
(10) Pub. No.: US 2006/0237427 A1
(43) Pub. Date: Oct. 26, 2006

(54) Smart cabinets

(76) Inventor: James D. Logan, Candia, NH (US)

Correspondence Address: CHARLES G. CALL, 68 HORSE POND ROAD, WEST YARMOUTH, MA, 02673-2516, US

(21) Appl. No.: 11/398,791

(22) Filed: Apr. 6, 2006

Related U.S. Application Data
(60) Provisional application No. 60/669,219, filed on Apr. 7, 2005.

(51) Int. Cl. F27D 11/00; A21B 1/00; A21B 1/22

(52) U.S. Cl. 219/401

(57) ABSTRACT

Methods and apparatus for managing the content of containers, such as existing kitchen cabinets, refrigerators, storage rooms and lockers, and medicine cabinets. Controllable latching modules and/or cameras are attached to the containers to control access to and/or record changes to the contents of the containers. The latching modules include an electromechanical device controlled by a microprocessor or responsive to electronic signals from an external source to permit or deny access to the container at predetermined times, or permit or deny access to specific persons, or under other conditions specified by a rule based control system. In addition, the camera may be used to reveal changes in the contents when the door to the container is open.

### CROSS REFERENCE TO RELATED APPLICATIONS

This application is a Non-Provisional of and claims the benefit of the filing date of U.S. Provisional Patent Application Ser. No. 60/669,219 filed on Apr. 7, 2005, the disclosure of which is incorporated herein by reference.

### FIELD OF THE INVENTION

This invention relates to an electronically programmable latch or lock which can be installed to control access to the contents of an existing container, such as a kitchen cabinet, a refrigerator, a room, or a storage locker.

### BACKGROUND OF THE INVENTION

Cabinets in hospitals that contain specific drugs have had microprocessor controls and controlled access for many years, allowing only authorized personnel to access certain compartments. Banks have had vaults that open and close on a set schedule. There is a need, however, for programmable locking mechanism that can be retrofitted on existing household containers, such as kitchen cabinets, refrigerators, and the like.

A number of previously issued U.S. patents describe door access control and monitoring systems that illustrate prior attempts to solve related problems. These patents are briefly summarized below and each of their disclosures is incorporated herein by reference.

Remote control door lock systems have been devices which can be operated by remote signaling mechanisms under microprocessor control. For example, U.S. Pat. No. 6,046,681 issued to Solop on Apr. 4, 2000 describes a remote control lock in which a locking bolt engages with a striker plate disposed in a doorjamb. A solenoid is used for retracting the lock bolt from engagement to the striker plate, and a microcontroller and associated circuitry receive and decode an access code to energize the solenoid to unlock the locking bolt.

U.S. Pat. No. 5,016,453 issued to Bonnice, et al. on May 21, 1991 describes a timed refrigerator lock consisting of a plate affixed by an adhesive to the side wall of the refrigerator, a shackle and link chain having one end secured to the plate, a housing mounted by an adhesive on the refrigerator door including a mechanism within the housing for opening the shackle at a predetermined period of time so that a person can remove the link chain from the shackle and open the front door of the refrigerator to gain access therein to obtain food.

U.S. Pat. No. 4,835,520 issued to Aiello on May 30, 1989 discloses a talking alarm for openable compartment that uses message-generating apparatus for discouraging access to a compartment during predesignated time intervals. The apparatus includes a detector to determine when the compartment door is open and to produce a signal when this event occurs. If the event occurs within a predesignated alarm time interval, a microprocessor produces a reminder.

U.S. Pat. No. 4,463,348 issued to Sidebottom on Jul. 31, 1984 describes a refrigerator door usage monitor and display system in which visual indicia are provided to indicate to the user the degree of door usage on a rolling average time basis. Threshold time limits are established to correspond to heavy, normal and light usage. The actual door-open time is sensed and accumulated in successive time segments. The rolling average door open time over a predetermined number of time segments is calculated at the end of each time segment and the appropriate lamp is lit depending on how the calculated average door-open time compares to the established threshold values.

### SUMMARY OF THE INVENTION

As used herein, the term “existing container” means an container which has been previously manufactured and installed, such as a household kitchen cabinet, a refrigerator, a storage locker, or an existing room, and which is includes one or more doors, lids, or other access opening that may be opened and closed. The present invention contemplates retrofitting a controllable locking mechanism into such existing containers to permit access to their contents only when one or more specific conditions are satisfied.

These and other features and advantages of the invention may be better understood by considering the following detailed description of specific embodiments of the invention. In the course of this description, reference will be made to the attached drawings.

### BRIEF DESCRIPTION OF THE DRAWINGS

FIG. 1 is a block diagram illustrating the principle hardware components of an embodiment of the invention;

FIG. 2 is an exterior view of a remote control unit employed in an embodiment of the invention;

FIGS. 3 and 4 show the manner in which a latching mechanism may be attached to an existing kitchen cabinet to lock and unlock an access door to the cabinet to control access to the contents of the cabinet; and

FIGS. 5 and 6 are side elevation views of an electromechanical latch used in the latching mechanism seen in FIGS. 3 and 4.

### DETAILED DESCRIPTION

The system of “smart cabinets” contemplated by the present invention would employ latches that could be attached to the inside of already-built cabinets and would serve to lock the cabinet door. Alternatively, latching modules may also be retrofitted onto existing refrigerators, storage lockers and rooms, and other existing containers. Each locking mechanisms includes an electromechanical locking device controlled by a microprocessor or responsive to electronic command signals from an external source and is used primarily to permit or deny access to the cabinet or container at predetermined times, or to permit or deny access to specific persons, or to permit access only a limited number of times within a predetermined period of time, or under other conditions described in more detail below. In addition, access doors may be equipped with a mechanism for automatically opening and closing the doors under the control of the system.

The present invention may be used to particular advantage to make foods and beverages available to specific people only at specific times. Uses for the product further include access control for children, access control specific equipment and the like for employees, and self-control assistance for people who are observing diets or otherwise attempting to control their access to the contents placed in specific containers.

The world's population grows more overweight by the year-and the most effective diet is to get tempting food out of reach. Lockable cabinets offer the convenience of having stuff items around when you want/need/deserve them without the constant temptation of having everything always available on-demand. Research has shown that availability alone is a major determinate in food consumption. Studies of the consumption of chocolate “Kisses”, for instance, have shown that placing the candies just a few feet further away reduced consumption by over 60% and placing them in a container reduced consumption further still. While the components used to implement the some embodiments of the invention may appear to be expensive today, their cost is declining rapidly and the needed devices are already easily affordable by consumers who spending ever-greater amounts of money on kitchen renovations and expensive appliances such as refrigerators, and who often spent considerable sums on dieting systems.

The system may be battery powered, or may be powered by a power supply connected to a suitable power source to avoid the need to maintain charged batteries. Alternatively, an electrical storage device might be used that could capture energy from the very cabinets being opened and closed. This could only be used for cabinets that are used often enough to charge the battery or alternatively, the system could build resistance into the act of opening and closing the door with such extra energy being captured by a generator and used to recharge the battery.

By way of example, using the controllable locking mechanism contemplated by the present invention, a user would be able to open and gain access to a container in the following ways:
1. In the simplest implementation, the latching mechanism may be programmed to be locked at predetermined times and openable at other predetermined times. Merely pulling on the handle opens the container if it is openable at that time.
2. Alternatively, a remote control device, similar to a wireless TV remote, could be used to signal the cabinet to unlock, after which it could be manually opened. The advantage of the remote control is that possession of the remote itself allows for access (in conjunction with the fact that the cabinet is programmed to open at that time.) It also makes the process of opening a cabinet a two-step process—one that requires a bit more forethought and effort.
3. The system may include a mechanism that allows a person to identify oneself to the system by inputting a password or pin-number, or by identification information acquired by a biosensor. In this manner, different opening rules can be devised for different persons. In a single person household, or a household where actions of various household members didn't need to be distinguished from each other, no method of identifying specific users would be needed.

Control rules could be created at a central device such as a personal computer (PC) that could use infrared or radio signaling to send control signals, or program rules, to the locks. The rules could be stored locally and then implemented directly from logic embedded in the locks themselves, or the locks could be “dumb” and respond to commands issued by the PC or remote control unit which determines whether or not predetermined conditions are satisfied permitting access. The processing may also be provided on a server which provides processing capabilities using a web browser interface, or as a web service. With a connection to a PC or a direct Internet connection the locking mechanisms could communicate directly with software residing either on a remote control device, on a PC, or anywhere on the Internet.

A supervisory master device such as a PC or remote server or both could be used in conjunction with a remote control unit, whereby the PC or server is used to program rules into the remote control unit, where rules would then be stored and executed to determine when specific locks should be opened and closed. The remote control may also contain a timer, process rules, and in turn, be used to transmit locking and unlocking commands to the locking modules, or to transmit rules or date to the processor in the locking mechanism that operates independently to control the locks. With a remote control unit containing the rules, the user would press one or more keys to enter access codes or otherwise signal a desire to unlock one or more containers. The remote control would then send an “open” signal to the cabinets if they were “allowed” to be opened at that time.

A remote control based system could also be envisioned whereby there is no controlling PC or Internet based software but rather the rules are programmed directly into the remote control unit itself which operates independently of any devices other than the locking mechanisms. Again, these rules could then be stored in the remote.

Alternatively, instead of using a remote control, the cabinets could be opened up with a simple keypad affixed to and accessible from the outside of the container, in a manner similar to a school locker. Conceptually, this is the same as attaching a separate remote to each door that needed independent access. A single keypad could control one or more cabinets if multiple cabinets could communicate with the keypad. In this configuration, the rules and the timer are locally based in the locking mechanism itself. Such a locking mechanism would still be microprocessor controlled with the microprocessor over-riding any illicit attempts to open the container, even by someone who knew the pass-code. In other words, to open a cabinet, the user would have to know the combination and the cabinet would have to be eligible to be opened.

In summary, the control system includes at least five main components: (1) a rules-creating interface; (2) an access code input means for accepting a password, PIN number or the like; (3) a data memory for storing rules and passwords,; (4) a timer; and (5) a processor for generating command signals to lock and unlock the locking module(s). Between two and four devices could be employed to implement a rules-based system including: A PC-like device (and/or a connected server), a remote control, a keypad, and a smart lock able to communicate with a control means. The functions which can potentially be performed by these devices are listed in Table 1 below:

TABLE 1

| | Interface | | Storage of | | Lock/Unlock |
|---|---|---|---|---|---|
| | for Rules | Password | Rules and | | Commands |
| Device Type | Creation | Entered | Passwords | Timer | Sent |
| A) PC | Yes | Yes | Yes | Yes | Yes |
| (and/or an | | | | | |
| Internet | | | | | |
| connected | | | | | |
| server) | | | | | |
| B) Remote | Yes | Yes | Yes | Yes | Yes |
| C) Keypad | Yes | Yes | Yes | Yes | Yes |
| D) Locking | | | Yes | Yes | Yes |
| Means | | | | | |

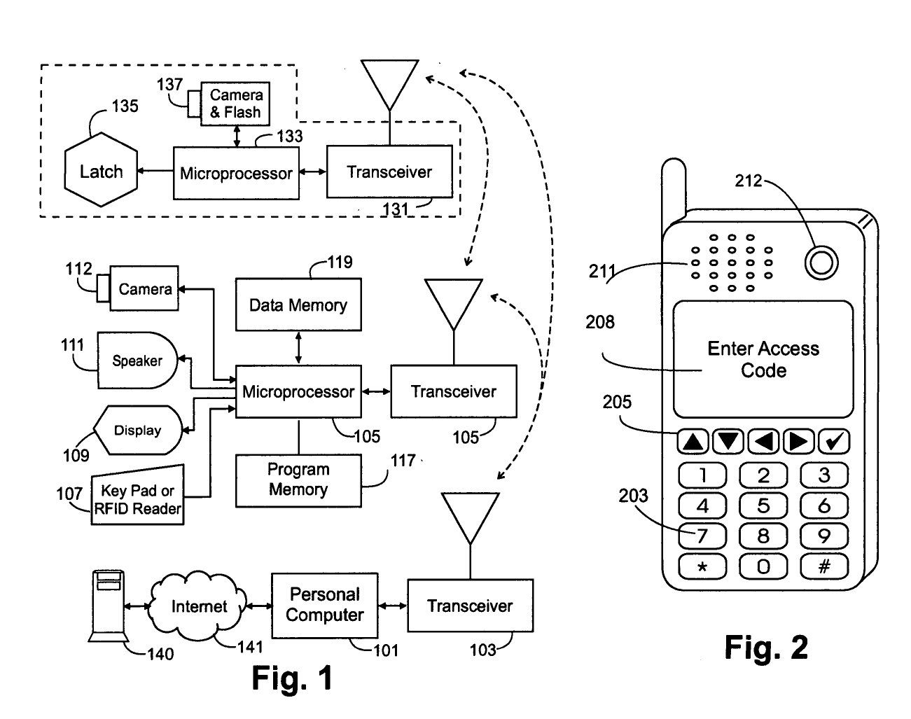

Possible combinations of devices to implement the system include: A&D; A-B-D; B&D; C&D; and A-C-D. An A-B-C-D embodiment is described in FIGS. 1 and 2 wherein a PC is used to communicate with both a remote unit and one or more locking modules, and a keypad is built into the remote unit. The programs executing on both the remote unit and the PC may be password protected against use by unauthorized person, and both may store rules and passwords, both may include times, and both may send lock and unlock commands to each locking module, which includes its own processor/timer for independent operation of the lock.

A communication link between the components can readily provided by an infrared or wireless data link (such as a link between Bluetooth® chips) since the amount of data to be transmitted is small. In the A-B-D configuration, for instance, where the remote stores the data and rules, the information could be easily loaded into the remote via a cradle or IR link. The link between the remote and the locking means could be a low cost IR (which would require an unsightly LED perhaps) or a radio means such as Bluetooth that could penetrate limited thicknesses of wood.

To power the limited on-board electronics and the latch operating solenoid, low-voltage wiring may be used to provide power to each latching module and to further allowing communications with a minimum number of cabinets and receivers (instead of each cabinet being able to communicate). The power supply for the latching modules could be included in a wall mounted remote control unit linked to each cabinet by the low voltage wiring. The user could pick up the remote, or go to the keypad, and input his or her ID number, and those allowed cabinets would then all open for the allowed upon time, or commands to open and close individual cabinets could be addressed to specific modules. Wiring between cabinet units would also allow for the economic deployment of better communications equipment, such as a WiFi link, that would support advanced features such as those discussed below employing the use of cameras.

FIGS. 1 and 2 show an illustrative embodiment of the invention consisting of a personal computer 101 which includes a short range Bluetooth® wireless transceiver 103 that exchanges data with a Bluetooth® wireless transceiver 105 in a hand-held or wall mounted remote control unit whose exterior is seen in FIG. 2. The remote control unit includes a keypad seen at 107 in FIG. 1 which, as seen in FIG. 2, consists of a ten-digit numeric keypad 203 and a set of menu navigation and selection buttons seen at 205. As discussed later, the unit may also employ an RFID reader to identify a tag or badge carried by the person requesting access, who need not enter an access code. The remote control unit further includes a small LCD display (109 in FIG. 1 and 209 in FIG. 2). A small speaker (111 in FIG. 1 and 211 in FIG. 2) is employed to produce spoken announcements or audible alarm and/or alert signals. A camera seen at 112 in FIG. 1 and at 212 in FIG. 2 is incorporated into the remote control to capture the image of the person requesting access to the contents of a container locked by one of the latching modules controlled by the system.

The remote control unit includes a microprocessor 115 which may be augmented with additional program memory as indicated at 11 7and/or with additional data memory as illustrated at 119. The remote control unit seen in FIGS. 1 and 2 may be implemented by programming a conventional, Bluetooth enabled cellular phone or Personal Device Assistant (PDA).

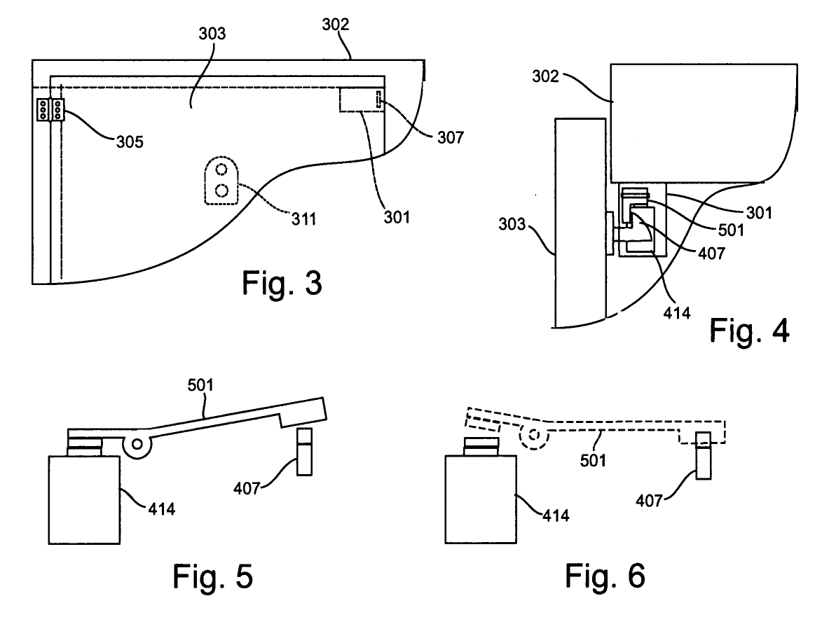

The personal computer and the remote control unit may both communicate directly with a Bluetooth(® wireless transceiver at each of one or more access control latch mechanisms, one of which is shown in the block diagram at the top of FIG. 1. The transceiver 131 is connected to a microprocessor 133 in the latch mechanism which is connected to lock and unlock an electromagnetically operated latch mechanism seen at 135, an example of which is described below in connection with FIGS. 3-6.

The personal computer may execute an application program which may be supplied to the consumer on a CD delivered with the remote control unit and whatever number of latch mechanisms are also needed to satisfy the customer's needs. Alternatively, the PC 101 may serve as a conduit to a remote server seen at 140 which is connected to the PC 101 via the Internet as indicated at 141, with substantially all of the processing being done at the server 140. For example, the server 140 may include a web server which interoperates with a web browser that executes on the PC or on the remote control unit, and which accepts data entered by users as well as identification data identifying the Bluetooth transceivers in locking mechanisms that are within range of the PC or the remote control, and transmits locking and unlocking commands via the Internet 141 and the PC 101. Both the personal computer and the remote control unit can identify all of the Bluetooth® transceivers within range. In those applications where both the PC and the remote control unit are within range of a given latch module, that module may be controlled by either the PC or the remote control. In many applications, however, the remote control unit will be placed near to the latch modules that it controls, since the user who wishes to gain entry into a particular container or enclosure will frequently use the remote control, for example, by entering an access code into the keypad 203 seen in FIG. 2. The longer range capabilities of the Bluetooth protocol may be used to establish relatively long range communications between the PC and remote control unit, while the low power, short range signaling capabilities of the Bluetooth transceiver are used to communicate with the latching modules, which helps conserve battery power in the latching modules to reduce the frequency with which new batteries need to be installed. The remote control unit may be used as a relay station, receiving control signals from the PC and retransmitting them via a short range Bluetooth link to nearby latching modules to which the PC had directed control commands.

The PC may be used not only to transmit control signals to lock and unlock latch modules which are within range, but may also be used to transfer programs and data to the microprocessors in both the remote control unit and in the latching modules which are thereafter executed by those devices to control their operation. For example, the PC may be used to store the names of particular users, and their assigned access codes, along with the times of day each user is allowed to use the remote control unit to unlock a specified latching module. The program executing on the PC provides an understandable user interface that simplifies the task of establishing the rules which are to control the locking and unlocking of specified latching modules at particular times, or by particular people, or under numerous other conditions or restraints which have been described above. After the system has been properly configured with the user's preferences using the PC, control commands, programs, and data may then be transferred to the remote control unit and to the individual latching mechanism to enable both the remote control unit and the latching mechanisms to function as directed. For example, the PC may be used to specify that the microprocessor 131 in a given latching mechanism is to be directly programmed to unlock the latch 135 on designated days of the week at specific times only, unless overridden by a command from the remote control unit or the PC entered by a person who first supplies a designated access key value.

One or more cameras may be used to capture images of the contents of particular containers and, as illustrated at 137 in FIG. 1, these cameras may be connected to the same processor that controls the locking mechanism for that container. As described in more detail later, these cameras may be used to capture an image of the contents of the container each time the container door is closed, or each time an image capture signal is received from the connected processor (which may be at the same time a door is unlocked). By comparing an image taken before and after the container door is open, it is possible to identify the image of any item which has been, moved, removed or added to the container while the door was open. As described in more detail below, this image data may be used in a variety of ways to better manage the content and use of the containers.

While using a PC to manage the system provides valuable advantages, it is by no means essential. The remote control unit may also execute programs stored at 117 to provide a robust user interface that allows the user who first enters a specified access code to navigate a menu of programmed options displayed on the screen 208 to perform a variety of configuration and command execution functions, including pre-programming specified latching mechanisms to lock and unlock as specified times, to accept the identification of users and manage their access codes, to program the rules which will govern the rights given to particular users to lock and unlock specified modules, including specifying the days of the week and the times of day that particular users who enter their assigned access keys will be allowed to perform certain functions.

The principles of the present invention may be used to control a wide variety of different electronically controllable latching mechanism, and a simplified example is presented in FIGS. 3-6 as an illustration. The latching module is seen generally at 301 in FIG. 3 and is used to lock and unlock a kitchen cabinet door 303 mounted on hinges, one of which is seen at 305. The housing of the module 301 is attached by screws or other suitable fasteners to the underside of the cabinet 302 at the top of the door opening as seen in FIGS. 3 and 4. An outwardly projecting flange seen at 307 in FIG. 1 and at 407 in FIG. 4 is attached (typically by wood screws) to the door 303 and has an upwardly projecting hook at its distal end that projects through an opening in the latching module 301. A self contained digital camera with a wide angle lens and an LED flash seen at 311 in FIG. 3 is attached to the inside of the cabinet door 303 facing the contents of the cabinet. The image data captured by the camera may be transmitted via a Bluetooth connection to the nearby transceiver in the locking mechanism, or in the remote control unit, which also receives image capture commands to operate the camera and the flash to capture an image of cabinet contents. The camera may take the form commonly used in low cost web cams that include, for example, a CMOS image sensor with VGA resolution of 640×480 pixels.

As seen in FIGS. 5 and 6, the latching module includes an electromagnet seen at 414 which controls an pivoting latch 501 between an unlatched position shown in FIG. 5 and a latched position shown in FIG. 6. When the electromagnet 414 is energized under the control of the microprocessor 133 (FIG. 1), it pivots the latch member 501 in a counterclockwise direction as seen in FIG. 5, lifting the end of the latching member adjacent to flange member 407 which is attached to the door, so that the latching member 501 no longer engages the hook end of flange 407, allowing the door to open. Note that the electromagnet 414 need only open briefly to allow access to the

The ability to control several cabinets, even when in close proximity to each other, could be accomplished in one of several ways:
1. Each cabinet (locking module) could have a unique ID. When, for example, Bluetooth chips are used, the Bluetooth ID may be employed. The user, after inputting the appropriate user ID could address each cabinet, one by one, and request to open them. Such an approach would make access more deliberate than all cabinet being opened at once.
2. There could be no unique identifier for a cabinet, and the system would control all cabinets with the same rules. If a remote was being used, all cabinets could behave the same.
3. There could be different rules for different cabinets. The remote would have a very short range and just be able to interact with ones within signal range. In this way, no cabinet IDs would be needed.
3. The system could alternatively sense which direction the remote was pointing in and respond to that cabinet; for example, a line-of-sight infrared pickup could be positioned at each locking module which, when signaled, would transmit a request to the remote processor (or the local processor in the locking module) for permission to respond to the request. Thus, a simple hand-held IR transmitter could be pointed at the cabinet to be unlocked, so that only the bearer of the remote control could have access to the contents of the cabinet, and only at particular times of day, or only if the bearer first entered an access code

A pin or access code entered by the user may identify a specific person (who in turn knows the code). Alternatively, fingerprint recognition, iris scanning, a camera and image recognition (using the camera 112 seen in FIG. 1), voice recognition (using a microphone to capture the user's voice) may be used to as a biometric sensor to identify the user. Alternatively, the user may carry an RFID tag (badge) whose presence within range of the remote or a specific locking mechanism is sensed, and the cabinet may be automatically locked or unlocked based on the identity of the tag bearer, the time of day, and any other conditions established by the rules-based processor.

Multiple cabinets, or even one, could be controlled by a web of interlocking rules established using a PC or server as described in my U.S. Pat. No. 6,631,271 issued on Oct. 7, 2003 entitled “Rules Based Methods and Apparatus for Generating Notification Messages based on the Proximity of Electronic Devices to One Another”. The cabinet latch, once installed, could be programmed to be in concert with the following rules and any combination thereof:
1. Open only for certain people identified by access code, biometric sensing, or RFID badge sensing.
2. Be open only for certain hours of the day.
3. To be opened only a set number of times in a set time period, and for a set amount of time for each opening.
4. To be only openable during certain days of the week.
5. To be opened based on the number of previous transgressions recorded per person per time period. For example, a rule may be established which sets up the conditions that, if a specified person has opened the refrigerator door and the door of a kitchen cabinet containing food more than four times on a given day, the system may issue an audible warning signal using the speaker 111, and display a warning message on the display screen 109, and then refuse access to both the refrigerator and the cabinet after either was opened for a combined total of more than six times.
6. If cabinets had RFID readers or other means of automatically sensing the contents within cabinets, the opening rules could be a function of what was stored in the cabinet-and how long something had been in there for, or could track when items are removed from the cabinet. The characteristics individual items identified by RFID tags containing Electronic Product Codes (EPCs) may be determined by using the Object Name Service (ONS) and the EPC Network, or using the Global Data Synchronization Network, established under the auspices of EPCglobal Inc of Lawrenceville, N.J. Alternatively such information could be input manually either at the controlling PC or via the input means associated with accessing the cabinets (i.e. keypad or remote); for example, the user could enter the number of calories contained in whatever products were removed from a container, and the system could then warn the user, or lock the food containers, when the total calorie content exceeded a specified threshold.
7. If the RFID reader could read the number of units left, or if that information was known in some other manner, or if that information could be deduced via information concerning entry patterns, then the quantity of a specified item remaining could determine the access rules.
8. Access may be based on exogenous input such as information transmitted from a Bluetooth enabled exercise bike or weighing scale, or from instructions communicated from another person, such as a doctor or personal coach, via the Internet.
9. The remote control unit may be implemented using a programmable Bluetooth enabled cell phone or other hand-held device such as a PDA. The hand held device can also communicate via an infra-red or other communications means. Such a hand held device might be a GPS unit, or be GPS-enabled, allowing location-time information to be communicated to the Smart Cabinet system and used to modulate cabinet access. For instance, if GPS tracking data from a cellular phone or other device indicated that the user had spent the last two hours at a restaurant location, the system could deny access to one or more cabinets. Alternatively, if the tracking date the person had been at the gym for an hour, or had taken a two mile long exercise walk, a different set of rules might apply.

During certain hours, such as meal preparation time, access to containers in the kitchen could be always-on, or at least open to the meal preparer would be treated differently during this time period than during other time periods. Similar allowances would be made for unloading groceries. The information provided by a GPS-enabled device would be of assistance in this instance, as well. If the system incorporated a means for the cabinet doors to close, under system control, than closing rules could be modified during events such as meal preparation and grocery unloading.

The devices could also be used to encourage consumption of some items, such as daily drugs. If a cabinet were not opened during a set time period, a message could be sent over the Internet to a concerned relative, or a warning beep could go off inside the house, a light could flash, the door could spring open, etc. For example, the system may be used to monitor whether a particular person opened a medicine cabinet door at particular times, and issue a warning alert if that did not occur, indicating that the person may have failed to take medication when indicated by a prescribed regimen. Thus, the invention may be used to provide functionality of the type described in U.S. Pat. No. 5,408,443 entitled “Programmable medication dispensing system” issued on Apr. 18, 1995 to E. D. Weinberger, the disclosure of which is incorporated herein by reference.

In addition, small LCD displays as shown at 208 in FIG. 2 for the remote unit, or affixed to the cabinet, or built-in in the first place, may be used to display usage patterns and usage rules. They could display the time until the lock was released. In their simplest form, when no PIN was required for instance, cabinet signals such as a colored LED could indicate the lock was unlocked. Colored LEDs could also indicate who was allowed access at what time period.

Peripheral devices such as displays, exterior lock access means (such as an affixed keypad), or alarms would again, be battery or AC power-driven and communicate with the microprocessor controlling the locks. Ideally, the minimum amount of intelligence would go into the locking means itself, so long as the lock can respond to a signal, the intelligence can reside in the remote control, a PC, or a remote server connected via the Internet.

A warning sound might also go off if the battery started to run low. The locking mechanisms would ideally be designed in such a manner such that if they did lose power, they would open up. (In an extreme example, batteries could serve as a backup power source in case of a blackout.)

In addition to a scenario where a lock was opened or closed upon command, the system could be set up in less binary manner. That is, a command might be given to open a lock, but the unlocking action might not happen until some time had elapsed.

Time-delay could be one of several ways in which “friction” could be introduced into the system. Another form of friction would involve a system that allowed access upon “payment” of some kind. Such payment could be in the form of points that were allocated to each user over the course of a time period. Once the points had been used up, access rules would change.

A more open-ended system would allow a user to “buy” access at any time by paying into an account. The payment could be of real money and the account could be a charity or 401K savings account. Alternatively, points could be earned for various physical tasks or exercises performed, with such data being supplied by equipment that communicated such information (i.e., a Bluetooth enabled treadmill) or by hand under an honor system.

Another point system might involve relative behavior. If a person was trying to help a spouse stay on a diet, than transgressions of that person would allow the spouse to similarly transgress the rules. In such a system, competition between multiple people (even in different households) could be a useful stimulus to achieve the desired behavior.

As the cost of food has plummeted, its cost is no longer a useful means for rationing its use. Everybody can easily afford more of whatever they might like. Thus these friction-based or payment-based systems are an attempt to raise the effective price of the food and to introduce some cost to go along with the associated benefit of the food.

In an extreme scenario, a user might have a desperate need to open a cabinet “against the rules”. To accommodate this mode of behavior the system could do the following:
1. The locking mechanism may allow the user to force open a “locked” cabinet with no untoward consequences. At a minimum, some noise needs to be emitted or a feat of manual dexterity or force would be required. In another implementation such emergency use would allow the cabinet to be opened in a certain amount of time after inputting the request. This time delay would serve to reduce the immediate gratification aspect of the emergency entry, while still allowing for eventual access.
2. The system allows the behavior above, but in addition monitors (and reports) this behavior. The cumulative result of such behavior by a given user could be used to modify the rules over time making such emergency access more difficult or “costly” in terms of time or effort.
3. The system could offer a “sacrificial part” that would break upon the yank, thus allowing the door to open. This part might be easily installed but cost $5-10 to replace thus discouraging this behavior. This is the best solution in many respects, as it provides for continuing income for the manufacturer along with assurance to the customer that he can get in if needed, but also allowing the abuser to offer a penance in the form of the payment.
4. Another form of sacrificial action could result in the user having to make a donation of some sort for every out-of-bounds access of the cabinet. The system might record the cumulative accesses of a parent and would automatically credit his daughter's PayPal account as a result.
5. A more generalized approach would create debits and credits for good and bad behavior. At periodic settlement times, payments to charities or other entities could be made if the user was in “the red”. An interesting variant on this approach would have the manufacturer offer a rebate on the product that would be paid if the account was in the black at a certain point in time.
6. In another business model, the system could be linked with an organization such as Weight Watchers. Data would be exchanged with such a group (data not just about “out of bounds” behavior, but all behavior) and used to reward (or not), inform, and modify the treatment of participants. Weight Watchers provides downloadable software that may be used on a Bluetooth enabled PDA for monitoring a participants progress. This data may be communicated to the Smart Cabinet system, or the same PDA may be used as a handheld remote control, to implement the invention.
7. Often people overeat after consuming too much alcohol. Thus another use of the system's intelligent remote control could be offer a sobriety test before allowing a cabinet to be opened, such test perhaps coming at certain late-night hours. Such tests are used on systems that control access to cars and a similar approach could be used here.

Although the preferred embodiment of the invention employs locking modules that may be retrofitted into existing containers, some or all of the locking modules may be built into cabinets, or product containers (similar in some ways to the child-proof aspirin bottles). In addition, this access system could be added, or built-in to refrigerators, pantries, cookie jars, alcohol closets, stand alone crates, or closets. For example, a system purchaser could order and install one or more modules for installation into existing cabinets, refrigerators or the like, and might also purchase containers such as food chests, cookie jars, or medicine chests with built in locking mechanisms that communicate and interoperate with the same remote control unit.

If the remote control had two-way connectivity, it would be possible to have the system compile usage data.& This could be presented on the remote or compiled and presented on the PC. In addition, it would be possible to program the system such that usage information could be transmitted over the Internet or via cell phone (using WAP or text messaging) to other interested parties. This reporting could be done in real-time or in batch mode at a later time, or both.

The ability to be able to retrofit a Smart Cabinet system into an existing set of cabinets is important. Kitchen cabinets can cost tens of thousands to replace and the growth in the U.S. housing stock is less than two percent a year. Thus to be widely available, the system needs to be able to be easily installed on existing cabinets.

It is also important that the locking mechanism be out of sight. Thus, the retrofitable locks must be able to be mounted inside the cabinet and not seen when the door is closed. As most kitchen cabinets are made of wood, screws or glue would suffice to affix the locking mechanism to the inside of the cabinet.

The smallest part of the locking mechanism, (the piece that receives the sliding bolt if a bolt type is used, or the projecting flange seen at 407 in the latching mechanism seen in FIG. 4) would be mounted on the swinging door. Thus when the door is open the smallest piece is visible on the door. The other side would be mounted on the backside of the door jamb against which the door closes or on the underside, and edge, of a shelf as illustrated in FIGS. 3 and 4.

As many cabinet doors open side by side in pairs; accordingly, a single locking module may be used to lock and unlock both the left and right doors at the same time, using a single shared control and communications mechanism to control both doors.

Ideally, the radio frequency used for communications means could penetrate the wood substrate. If the system used a “line of sight” means of communicating, such as IR, an exterior “eye” or LED would be needed to receive a signal.

The locking module should be mounted at the appropriate height within the cabinet, such height being the height from which the user is likely to grasp the cabinet door or the height of the door handle if there is one. This would offer the user the least amount of leverage in opposing the lock. If the lock were located far from the handle, the door then would serve as a lever to pry the lock open.

To minimize the number of communication and power components for a multi-cabinet setup, it would be advantageous to have components for each cabinet linked together via low voltage wiring. Such wiring could be disguised under an adhesive tape that could be run on the shelf of the cabinets and through the cabinet walls to connect together multiple units. For systems built into new cabinetry, the wires could be run down grooves between wood panels and thus kept out of sight in that manner. In either case, the transformer and other “overhead” components could be placed in far-off, less used cabinet space.

The locking mechanism would ideally require low power, be of reasonable strength, be quiet when actuated, and have significant “closing tolerance” so that if it were installed in a less-than-precise manner, or the cabinets warped a bit, the lock would still function properly. In a battery operated system, the locking mechanism should consume power only when a transition is made from one state to another. In the event of a power or battery failure, or the loss of communications with a remote control processor, the latching system should automatically assume an unlocked state to permit access to the container.

Retrofitting a refrigerator or other non-cabinet-like structure would be more difficult as mounting to the inside would be problematic. In the case of a refrigerator, the apparatus could be affixed with adhesives and located on the top or bottom of the refrigerator, as far out as possible on the door for maximum leverage. The chain link and shackle arrangement of the type described in U.S. Pat. No. 5,016,453 issued to Bonnice, et al. on May 21, 1991, discussed in the introduction, may be used to lock and unlock a refrigerator door.

Monitoring by Image Capture

As seen in FIG. 1 at 137 and in FIG. 3 at 311, a camer may be used to monitor the changing contents of a cabinet, and a further camera seen at 112 and 212 in the remote control unit may be used to track the coming and going of people and to monitor the home for security purposes, and to potentially identify people who use the remote control by image recognition.

The cameras used to monitor the content of cabinets need only capture images between door openings since the contents of the container do not change between door openings. Therefore only a limited number of still shots can capture all the information related to changes in the cabinets' contents.

It would be useful therefore to add one or more small wide-angle cameras, connected to the Smart Cabinet's system for monitoring contents within the cabinets. Such camera components, now commonly uses as “Web cams” are low cost devices capable of capturing digital images having adequate resolution at low cost. The imaging system described below, could in fact justify the hardware for the Smart Cabinet system even if no locking system were desired. In that sense, the idea could stand alone as a distinct use of such circuitry and not merely as an added feature for an access-control system.

With such cameras, each time the door is opened, letting in light, the cameras could snap a picture of the contents of the cabinet. The image could be communicated via Smart Cabinet communications means, assuming it was a two-way system (the lock control function might only need to be a one-way system). Devices that could receive the images could include a PC, any device connected to the Internet, the remote if it had a video screen, and even a cell phone. Ideally, the user would be able to access such images on a cell phone while shopping, or when preparing to shop, and such images could be used to remind the user of items to purchase.

The light source could also be a flash. One advantage of the flash is that no door sensor would be needed, it could merely shoot a picture at the end of every set time period. If door sensors were used and a flash were available, the status of the contents could be recorded after the door was shut (presumably a door-opening event meant that something had been removed and thus shooting the picture after the door had closed would capture that change).

Alternatively, using only a door sensor and no flash, an after-the-activity picture could also be generated if the sensors could establish when a door was being closed and shot the picture at that moment while light was still flowing into the cabinet. But if multiple accesses to the cabinet occurred, this could create a surfeit of images. Thus simply flashing a picture after all activity had ceased and the door closed would be the simplest approach.

Another alternative to placing cameras inside the shelves would be to place them on the cabinet doors. With the appropriate door sensor, the camera would shoot a picture of the interior when positioned at an appropriate angle. Such an open angle would give the camera a better field of view than the one from a camera mounted inside the cabinet. Installation and wiring of such a camera, and the timing of such shooting, would be challenges, but the perspective for the shoot might be better and the number of cameras needed might be less than the alternative of a separate camera inside for each cabinet shelf.

Such images might be more usable than text-based product lists generated by RFID readers used systems described in prior art. In addition to the visual information content contained in pictures of individual items, the information content contained in the visual illustration of how the shelves are organized would be of assistance too in determining future product needs. In other words, the location of specific objects on various shelves is an integral part of one's “mental map” of what is needed in the house. Stored images representing this mental map would be useful to access when away from the home.

Combining an RFID reader with the image software could, however, provide the best result of all. The RFID information could be used to solidify the information supplied by the image database and provide more specific brand or product-type information than could be deduced by visual information alone.

The images of the shelves could also be used, in conjunction with image recognition software, to track the use of various items over time. This would be done by running pattern-matching software on the images taken after each successive opening of a cabinet. By comparing successive images, items had been moved, added or removed when the container door is open can be readily identified. Image recognition techniques may be used to match the image of a moved item against a database of images of products, or product types.

Such product-specific usage information, when combined with a person's ID information input with the remote control or keypad used for access, could be used to deduce what consumption was taking place upon access at certain times by certain people in certain cabinets. Such data could be used to reformulate the access rules. Thus, if household member X kept accessing the cookie jar during allowed visits to a certain cabinet (noted by the system because the cookie jar moved slightly in the images taken after each opening of the door) then the rule allowing such access might change.

Alternatively, if person X was not allowed access to the cookie jar, and the system noted such jar had moved from cabinet A to cabinet B, then the access rule for cabinet B might change regardless of X's behavior.

Such a system employing camera equipment would best be built into a refrigerator by the OEM as opposed to being retrofitted. It would include multiple cameras able to snap pictures of various shelves and compartments and the means to communicate such pictures to another device. Convex mirrors could be placed in line-of-sight of the cameras in order to create images of what was kept on the refrigerator door shelves.

Ideally, the cameras (for either the refrigerator or cabinets) could be activated via remote control and not just when the door is opened thus allowing the contents of the refrigerator or cabinet to be perused from the comforts of one's PC screen or cell phone or cell phone on-demand.

The refrigerator camera could also make use of the refrigerator's internal light turning it on to illuminate the inside when the refrigerator door is closed. Alternatively, a small flash could be built in.

Multiple cameras could be installed in each cabinet and even each shelf to gain the needed images. In order to minimize the number of camera components needed for a cabinet or refrigerator setup, however, sections of an optical light guide (flexible glass or plastic piping) could be installed in various locations within the refrigerator or cabinets allowing one camera mechanism to shoot shots from multiple angles, provided a means was provided to switch the camera view from light pipe to light pipe. Such a system would also allow such light guides to be aimed outside the cabinets or refrigerator and thus also serve the monitoring function often done with webcams.

In addition, mirrors, which may be curved, could be mounted in the back of certain spaces or shelves, opposite the camera or light pipe. When a picture was taken, the mirror would present an image of the contents in the space as seen from the opposite side of the space from the camera The image on the mirror could be automatically extracted from the larger image via software and inverted and enlarged to provide meaningful information. In fact, all the shots taken with the wide-angle lens or via a curved mirror could be automatically adjusted to minimize the distortion resulting from the use of such a lens.

An alternative way to use the mirrors would be to rotate the camera so that it focused exclusively on each mirror, preferably with a zoom type lens.

In any case, software would combine all the available imagery of all the cabinets at one time in order to create a synthetic view of what was in the cabinets. In this manner a person could “browse” the contents of the cabinets from anywhere. If using a computer monitor and pointing devices, the software could present a visual image of the cabinets as they look when in the kitchen. The user can click on a cabinet and be able to see the contents (or alternatively, the cabinets could be presented as if they had no doors). Using the data from cameras in the back of the shelves or from the mirror-reflected images, the system could offer synthetic 3-D type views allowing the viewer to “fly” through the cabinet and see objects from different angles. When combined with specific product information from RFID input, data about products could be called up as well.

Several high-end refrigerator models are today sold with an Internet connection and a touch screen interface on the front door. Such a system when combined with Smart Cabinet technology could offer several additional benefits. First, the cost of the Smart Cabinet (both locking and camera functions) would be reduced if component parts were shared with the touch module. Secondly, the images generated by the cameras could be displayed on the door of the refrigerator. Users could see what was in the refrigerator without opening the door. The image could be manipulated by the viewer to see items in the refrigerator in more detail. Alternatively, the system could automatically alter the display of images to “promote” healthy food, items about to expire, or present what was for dinner that night. In this way the camera system would generate a useful screen saver function for the display.

The image software could also keep track of the contents in the refrigerator as discussed above. It would know that a bottle of milk had been in the refrigerator of a week. The system could then issue a visual or auditory warning when the door was opened, or when the bottle moved, or the system could proactively send a notification over the Internet.

To supplement this function, the system could also add olfactory senses. Such sensors are also coming down in price. By adding one to the inside of the refrigerator it could identify rotten food, or food that needs to be consumed within a certain period of time. Again, notifications could be sent via email regarding such food items.

The system could also recognize Tupperware and make reasonable guesses as to what might be in the container. Thus is a blue Tupperware container showed up after dinner on Tuesday, on Friday the system would know enough to inform someone that the dish contained three day old food. In addition, if the system knew what was for dinner on Tuesday, it could deduce that those were the leftovers.

Using the image database users could also point to items on the screen, or pick them up and the system could offer information about the item, including calories, serving size, nutritional values, etc.

### Conclusion

It is to be understood that the methods and apparatus which have been described above are merely illustrative applications of the principles of the invention. Numerous modifications may be made by those skilled in the art without departing from the true spirit and scope of the invention.

What is claimed is:

1. Installable apparatus for controlling access by different persons to the contents of one or more pre-existing containers each having at least one movable access door comprising, in combination,
a locking mechanism attached to each given one of said one or more pre-existing containers, said locking mechanism preventing access to the contents of said container in response to a locking signal and permitting access to the contents of said given one of said containers in response to an unlocking signal, ‘an input device for acquiring identification data uniquely identifying a particular one of said different persons who desires to access said contents, and
a programmable processor including a timing clock for transmitting locking and unlocking signals to said locking mechanism in response to said identification data to permit access to said contents by said particular one of said different persons only at predetermined times.

2. Installable apparatus for controlling access as set forth in claim 1 wherein said identification data is an identification code value accepted from said particular person.

3. Installable apparatus for controlling access as set forth in claim 2 wherein identification code is accepted from said particular person using a manually operated input device.

4. Installable apparatus for controlling access as set forth in claim 2 wherein said input device is a biosensor for acquiring data representing a unique attribute of the physical characteristics of said particular one of aid different persons.

5. Installable apparatus for controlling access as set forth in claim 4 wherein said input device is located remotely from said locking mechanism.

6. Installable apparatus for controlling access as set forth in claim 4 wherein said manually operated input device and said programmable processor are located remotely from said locking mechanism.

7. Installable apparatus for controlling access as set forth in claim 4 wherein said manually operated input device and said programmable processor are located remotely from said locking mechanism and wherein said locking and unlocking signals are wireless signals transmitted form said programmable processor to said locking mechanism.

8. Installable apparatus for controlling access as set forth in claim 7 further comprising a personal computer coupled to said programmable processor for transmitting programming signals to said programmable processor to vary the conditions upon which said locking and unlocking signals are transmitted to said locking mechanism.

9. Installable apparatus for controlling access as set forth in claim 7 further comprising a remote server coupled to said programmable processor via a communication pathway that includes the Internet for transmitting programming signals to said programmable processor to vary the conditions upon which said locking and unlocking signals are transmitted to said locking mechanism.

10. Installable apparatus for controlling access as set forth in claim 4 further comprising a personal computer coupled to said programmable processor for transmitting programming signals to said programmable processor to vary the conditions upon which said locking and unlocking signals are transmitted to said locking mechanism.

11. Installable apparatus for controlling access as set forth in claim 1 further comprising a personal computer coupled to said programmable processor for transmitting programming signals to said programmable processor to vary the conditions upon which said locking and unlocking signals are transmitted to said locking mechanism.

12. Installable apparatus for controlling access as set forth in claim 11 further comprising a remotely located server coupled to said personal computer via the Internet for transmitting programming data to said personal computer to vary the conditions upon which said locking and unlocking signals are transmitted to said locking mechanism.

13. Installable apparatus for controlling access as set forth in claim 1 further means for transferring rules-based executable programs from an external program source to said programmable processor to vary the conditions upon which said locking and unlocking signals are transmitted to said locking mechanism.

14. Installable apparatus for controlling access as set forth in claim 1 further comprising a camera for acquiring a digital image of the contents of said given one of said one or more pre-existing containers and means for processing said image date to identify changes to said contents.

15. Installable apparatus for controlling access as set forth in claim 14 wherein said means for processing said image data to identify changes to said contents comprises means for identifying differences between two successive images captured by said camera.

16. Installable apparatus for controlling access as set forth in claim 1 further comprising a camera for acquiring a digital image of the contents of said given one of said one or more pre-existing containers and means for rendering said images to one or more users to provide a depiction of said contents at different times.

17. Installable apparatus for controlling access as set forth in claim 1 wherein said input device for acquiring identification data is a biosensor for acquiring data representative of a physical attribute of said particular one of said persons.

18. Installable apparatus for controlling access as set forth in claim 17 wherein said biosensor is selected from a group comprising an iris scanner, a fingerprint sensor, a voice recognition sensor, and a camera for capturing an image of said particular person.

19. The method for controlling access to the contents of an existing container comprising, in combination, the steps of:
attaching an electrically controllable locking module to said existing container, said locking module comprising a lock and a controller for placing said lock in a locked state in response to a locking command that prevents access to said contents and for placing said lock in an unlocked state in response to an unlocking command the permits access to said contents,
recording a stored access code value in a data memory,
acquiring a submitted access code value from a person who desires access to said contents,
comparing said submitted access code value with said stored access code to produce an authorization signal when a predetermined correspondence exists between said submitted access code and stored access code value,
employing a processor for transmitting an unlocking command to said locking module to permit access to said contents when one or more predetermined conditions are satisfied, said predetermined conditions including the production of said authorization signal.
said predetermined conditions including when a submitted data value acquired from a person desiring access to said contents matches said stored access data value

20. The method for controlling access to the contents of an existing container as set forth in claim 19 wherein said step of acquiring a submitted access code comprises accepting a data value manually submitted by said person who desires access to said contents using an input device coupled to said processor.

21. The method for controlling access to the contents of an existing container as set forth in claim 19 wherein said step of acquiring a submitted access code comprises deriving said submitted access code from a biological attribute of said person acquired by a biosensor.

22. The method for controlling access to the contents of an existing container as set forth in claim 21 wherein said biosensor is selected from a group comprising an iris scanner, a fingerprint sensor, a voice recognition sensor, an imaging camera.

23. The method for controlling access to the contents of an existing container as set forth in claim 19 wherein said predetermined conditions further include the condition that the current time is within one or more predetermined time of day intervals.

24. The method for controlling access to the contents of an existing container as set forth in claim 23 wherein each given one of said predetermined time of day intervals is bounded by a stored time of day at which said given one of said intervals starts and and either a stored time of day at which said given one of said intervals ends or the duration of said given one of said intervals.

25. Apparatus for managing the contents of a container having an access opening that is normally closed and opened to permit access to said contents, said apparatus comprising, in combination,
a digital camera for capturing image data representing a sequence of images of said contents at different times,
a processor coupled to said camera for storing said image data, and
image rendering means for presenting said images to a user to depict the history of said contents at different times.

26. Apparatus for managing the contents of a container as set forth in claim 25 wherein said image rendering means includes means for comparing successive images captured at different times to provide an image of items included in said contents that were moved, removed, or added to said container.

27. Apparatus for managing the contents of a container as set forth in claim 26 wherein said successive images are captured before and after said access opening is opened to permit access to said contents.

28. Apparatus for managing the contents of a container as set forth in claim 25 wherein said apparatus further includes a controller for activating said camera to capture an image of said contents at least once during one or more time periods when said access door is closed.

29. Apparatus for managing the contents of a container as set forth in claim 25 further comprising:
a locking mechanism attached to said containers for preventing access to said contents in response to a locking signal and permitting access to said contents in response to an unlocking signal, and
means for operating said camera to capture said image data in response to an unlocking signal to capture an image of said contents before said access opening is opened.

30. Apparatus for managing the contents of a container as set forth in claim 29 further comprising:
an input device for acquiring identification data uniquely identifying a particular person who desires to access said contents, and
means for transmitting said unlocking signals to said locking mechanism in response to said identification data to permit access to said contents by said particular person when said identification data satisfies one or more predetermined conditions.
